(19) United States
(12) Patent Application Publication
(10) Pub. No.: US 2024/0423253 A1
(43) Pub. Date: Dec. 26, 2024

(54) TREATED GRAIN PRODUCTS BASED ON INTERMEDIATE WHEAT, AND PROCESSES FOR PRODUCING THE SAME

(71) Applicant: Agricultural Utilization Research Institute, Crookston, MN (US)

(72) Inventors: Lorrene A. OCCHINO, Circle Pines, MN (US); Michael W. STUTELBERG, Canby, MN (US)

(21) Appl. No.: 18/753,300

(22) Filed: Jun. 25, 2024

Related U.S. Application Data
(60) Provisional application No. 63/523,176, filed on Jun. 26, 2023.

(51) Int. Cl. A23L 7/10; B02B 1/04; B02B 1/08

(52) U.S. Cl. CPC A23L 7/197; A23L 7/198; B02B 1/04; B02B 1/08

(57) ABSTRACT

This invention treats intermediate wheat grain to enhance detectable characteristics such as a “spicy/cinnamon/sweet” attribute and/or an increase in readily extractable hydroxycinnamic acids, such as ferulic acid. A process for treating intermediate wheat to enhance its hydroxycinnamate extractability, comprises: providing a starting feedstock comprising grain from Thinopyrum intermedium; treating the starting feedstock in a reactor in the presence of water, for a treatment time selected from 1 hour to 8 hours, at a treatment temperature selected from 10° C. to 35° C., at a treatment pH selected from 5.0 to 8.0, and a mass ratio of water to starting feedstock of at least 1, thereby generating a treated grain. As a result of the treatment, the treated grain is characterized by at least 25% higher hydroxycinnamate extractability compared to the starting grain. The treated grain may be recovered as a milled flour product. Experimental data demonstrate the utility of the invention.

### PRIORITY DATA

This patent application claims priority to U.S. Provisional Patent App. No. 63/523,176, filed on Jun. 26, 2023, which is hereby incorporated by reference herein.

### FIELD

The present invention generally relates to treated grain products, and processes for producing treated grain products. The present invention also relates to improved processing of intermediate wheatgrass (Thinopyrum intermedium), and products obtained from such processing.

### BACKGROUND

Milling of grain is a physical process that results in the conversion of grain to flour by size reduction. The process changes the functional attributes of the grain and thereby enables different uses, such as baking. The resulting flour is improved for specific uses in making items for human consumption relative to the original harvested grain. Flour is commonly used in baking and other culinary practices.

Some flours have also found industrial uses not associated with human consumption. Flours with different functional attributes are desired for food and industrial uses. Some flours find preferential use over other flours because of a flavor profile that differentiates the preferred flour from others in the final product. There is a commercial desire for flours that possess unique natural flavors. An economical process to make such flours is also sought.

Perennial crops are a perennial plant species that are cultivated and live longer than two years without the need of being replanted each year. Perennial crops have a number of advantages. Perennial crops protect soil from erosion and improve soil structure. Perennial crops increase ecosystem nutrient retention, enhance biological carbon sequestration, improve water infiltration, and make nutrient uptake more efficient (less agricultural runoff). Perennial crops can contribute to climate change adaptation and mitigation. Generally, perennial crops help ensure food and water security globally.

In 2008, The Land Institute bred a perennial wheat crop known as Kernza®, a form of intermediate wheatgrass (Thinopyrum intermedium). Kernza is a domesticated (not genetically modified) form of wheatgrass designed to be planted from a single seed and regrow on its own, year after year (https://landinstitute.org/media-coverage/kernza-the-perennial-grain-with-the-potential-to-change-agriculture-forever). The roots remain in the soil, storing carbon and regrowing the plants to be harvested the next year. The grain harvested from intermediate wheatgrass (such as Kernza) can be used as a substitute for annual grains like wheat for production of baked goods, breakfast cereals, and snack bars.

There is a commercial desire to improve flavor characteristics of Kernza and other grains of intermediate wheat. Economical processes are sought for altering the product attributes of grain from intermediate wheat, for food applications. Economical processes are also sought for using intermediate wheat as a starting feedstock for making biochemicals, including hydroxycinnamates.

### SUMMARY

Some variations of the invention provide a process for treating intermediate wheat to enhance its hydroxycinnamate extractability, the process comprising:
(a) providing a starting feedstock comprising grain from Thinopyrum intermedium;
(b) treating the starting feedstock in a reactor in the presence of water, wherein the starting feedstock is treated for a treatment time selected from about 1 hour to about 8 hours, wherein the starting feedstock is treated at a treatment temperature selected from about 10° C. to about 35° C., wherein the starting feedstock is treated at a treatment pH selected from about 5.0 to about 8.0, and wherein the mass ratio of the water to the starting feedstock within the reactor is at least 1, thereby generating a treated grain; and
(c) recovering the treated grain, wherein the treated grain is characterized by at least 25% higher hydroxycinnamate extractability compared to the starting feedstock.

In some embodiments, the treatment time is selected from about 2 hours to about 5 hours.

In some embodiments, the treatment temperature is selected from about 15° C. to about 25° C.

In some embodiments, the treatment pH is selected from about 5.6 to about 7.5.

In some embodiments, the mass ratio of the water to the starting feedstock within the reactor is at least 10.

In some embodiments, the treated grain is characterized by at least 50% higher hydroxycinnamate extractability compared to the starting feedstock.

In some embodiments, the process further comprises drying the treated grain after step (b) to generate a dried treated grain product.

In some embodiments, whether or not the treated grain is dried, the process further comprises comminuting the treated grain after step (b) to generate a milled treated grain flour product.

The hydroxycinnamate extractability may be determined by measuring concentration of ferulic acid following chemical extraction of the treated grain. Alternatively, or additionally, the hydroxycinnamate extractability may be determined according to aroma.

Other variations of the invention provide a treated intermediate wheat grain product produced by a process comprising:
(a) providing a starting feedstock comprising grain from Thinopyrum intermedium;
(b) treating the starting feedstock in a reactor in the presence of water, wherein the starting feedstock is treated for a treatment time selected from about 1 hour to about 8 hours, wherein the starting feedstock is treated at a treatment temperature selected from about 10° C. to about 35° C., wherein the starting feedstock is treated at a treatment pH selected from about 5.0 to about 8.0, and wherein the mass ratio of the water to the starting feedstock within the reactor is at least 1, thereby generating a treated grain; and
(c) recovering the treated grain as a treated intermediate wheat grain product, wherein the treated intermediate wheat grain product is characterized by at least 25% higher hydroxycinnamate extractability compared to the starting feedstock.

In some product embodiments, the treatment time is selected from about 2 hours to about 6 hours.

In some product embodiments, the treatment temperature is selected from about 15° C. to about 25° C.

In some product embodiments, the treatment pH is selected from about 5.6 to about 7.5.

In some product embodiments, the mass ratio of the water to the starting feedstock within the reactor is at least 10.

The treated intermediate wheat grain product may be characterized by at least 50% higher hydroxycinnamate extractability compared to the starting feedstock. In certain embodiments, the treated intermediate wheat grain product is characterized by at least 100% higher hydroxycinnamate extractability compared to the starting feedstock.

In some product embodiments, the process further comprises drying the treated grain after step (b) to generate a dried product.

In some product embodiments, the process further comprises comminuting the treated grain after step (b) to generate a flour product.

The hydroxycinnamate extractability of the treated intermediate wheat grain product may be determined by measuring concentration of ferulic acid following chemical extraction of the treated grain. Alternatively, or additionally, the hydroxycinnamate extractability of the treated intermediate wheat grain product may be determined according to aroma.

### BRIEF DESCRIPTION OF THE DRAWINGS

FIG. 1 depicts an exemplary, simplified block-flow diagram of the process of the invention, in some variations, producing a flour product with enhanced hydroxycinnamate extractability compared to the starting intermediate wheat grain.

FIG. 2 depicts an exemplary, simplified block-flow diagram of the process of the invention, in some variations, producing a flour product with enhanced hydroxycinnamate extractability compared to the starting intermediate wheat grain.

FIG. 3 depicts an exemplary, simplified block-flow diagram of the process of the invention, in some variations, producing a hydroxycinnamate product and an optional milled grain co-product.

### DETAILED DESCRIPTION OF EMBODIMENTS

The compositions, materials, processes, and systems of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique. Concentrations may be intermediate to any recited values in a list of concentrations for a particular component.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of”′ limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus, in some embodiments not otherwise explicitly recited, any instance of “comprising” may be replaced by “consisting of” or, alternatively, by “consisting essentially of.”

The present invention generally includes contacting harvested intermediate wheat with water, at controlled reaction conditions, to create a detectable characteristic related to a spicy/cinnamon/sweet attribute in the grain or the flour derived from the treated and processed grain. The detectable characteristic can be experienced as an organoleptic spicy/cinnamon/sweet attribute by the physiochemical extraction process associated with aroma. The detectable characteristic can also be demonstrated by an increase in readily extractable hydroxycinnamates (such as ferulic acid) by physiochemical extraction in the laboratory and detected by high-performance liquid chromatography (HPLC), for example.

This invention increases the extractable hydroxycinnamates in treated grain or in milled treated grained products attributed by physiochemical extraction such as by laboratory extraction and detection by HPLC, or by aroma. The increase of extractable hydroxycinnamates is relative to grain or milled grain that has not been treated according to the disclosed process. The process involves contacting grain with water, such as by submersion, for a period from about 1 to 8 hours at a temperature from about 10° C. to about 35° C. Embodiments of the invention include contacting harvested grains with water to increase the readily extractable hydroxycinnamates such as ferulic acid in grain by at least 25%, that can be determined by extraction, and that persist in the flour derived from the treated grain as determined by extraction. The extractability of the hydroxycinnamates may be performed by mastication leading to a perceived aroma (e.g., taste) of a spicy/cinnamon/sweet flavor. Alternatively, or additionally, the extractability of the hydroxycinnamates may be performed in the laboratory after performing a chemical extraction, with the hydroxycinnamates detected by HPLC, for example.

Embodiments of the invention include contacting harvested grain with water in a vessel such that said vessel contains grain to which water is added to a point in which the grain is submerged in water at a pH from about 5 to about 8, such as pH 6.5-7.5. Once submerged the grain is left in contact with the water for a period of about 1 hour to about 8 hours, such as about 2-4 hours, after which the grain is separated from the water and the treated grain is processed for production of flour.

Other embodiments of the invention include contacting harvested grain with water in a vessel such that said vessel contains grain to which water at pH 5.6-8 is added to a point in which the grain is submerged in water. Once submerged the grain is left in contact with the water for a period of about 1 hour to about 8 hours, after which the grain is separated from the water and the treated grain is dried and processed for extraction of hydroxycinnamates, such as ferulic acid.

Some variations of the invention provide a process for treating intermediate wheat to enhance its hydroxycinnamate extractability, the process comprising:
(a) providing a starting feedstock comprising grain from Thinopyrum intermedium;
(b) treating the starting feedstock in a reactor in the presence of water, wherein the starting feedstock is treated for a treatment time selected from about 1 hour to about 8 hours, wherein the starting feedstock is treated at a treatment temperature selected from about 10° C. to about 35° C., wherein the starting feedstock is treated at a treatment pH selected from about 5.0 to about 8.0, and wherein the mass ratio of the water to the starting feedstock within the reactor is at least 1, thereby generating a treated grain; and
(c) recovering the treated grain, wherein the treated grain is characterized by at least 25% higher hydroxycinnamate extractability compared to the starting feedstock.

In some embodiments, the treatment time is selected from about 2 hours to about 6 hours. In various embodiments, the treatment time is selected as about, at least about, or at most about 1, 1.5, 2, 2.5, 3, 3.5, 4, 4.5, 5, 5.5, 6, 6.5, 7, 7.5, or 8 hours, including any intervening range. In other embodiments, the treatment time is longer than 8 hours, but this is not preferable for economic reasons. Also treatment times that are too long may damage the grain and/or the hydroxycinnamate extractability.

In some embodiments, the treatment temperature is selected from about 15° C. to about 25° C. In various embodiments, the treatment temperature is selected as about, at least about, or at most about 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., or 35° C., including any intervening range. Treatment temperatures higher than 35° C. may damage the grain and/or the hydroxycinnamate extractability.

In some embodiments, the treatment pH is selected from about 5.6 to about 7.5. In various embodiments, the treatment pH is selected as about, at least about, or at most about 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, or 8.0, including any intervening range. Treatment pH values lower than 5.6 (too acidic) or higher than 8.0 (too alkaline) may damage the grain and/or the hydroxycinnamate extractability.

One or more additives may be introduced to the treatment reactor, if desired. An additive is any species other than water or intermediate wheat grain. An additive may be added to adjust or buffer pH, for example. An additive may be added to adjust viscosity or processability of the intermediate wheat grain. An additive may be added because it is a desired additive in the final flour product. Such additives may include ascorbic acid (dough conditioner), L-cysteine (improves dough elasticity and gas retention), or glycerides (crumb-softening agent), for example.

The treatment pressure will typically be atmospheric pressure (nominally 1 bar). The treatment pressure is not regarded as a critical reaction parameter, and will usually be selected to achieve a convenient process. The treatment may be conducted under vacuum (pressure lower than local atmospheric pressure) if there is a benefit to removing gases generated during treatment, for example. The local atmospheric pressure in Denver, Colorado is about 0.8 bar. In some embodiments, the treatment pressure is selected from about 0.5 bar to about 2 bar. In various embodiments, the treatment pressure is selected as about, at least about, or at most about 0.5 bar, 0.8 bar, 1 bar, 1.2 bar, 1.5 bar, or 2 bar, including any intervening range.

The reactor may be agitated or non-agitated. When the reactor is agitated, the agitation means may vary widely, such as the use of an impeller, a magnetic stir bar, sonication (acoustic vibration), mechanical vibration, reactor rotation, and the like. Agitation may be used to increase the local Reynolds number during the treatment, which increases mass and heat transfer.

The reactor may be a batch reactor, a continuous reactor, or a semi-continuous reactor. In embodiments employing a batch reactor (such as Examples 1 and 3), the contents are treated in batch, with or without agitation. In embodiments employing a continuous reactor, the contents are conveyed through a continuous reactor, which may be a well-mixed continuous reactor, a plug-flow continuous reactor, or a reactor having a flow pattern intermediate between well-mixed and plug flow. A semi-continuous reactor means that either that the intermediate wheat grain is continuously conveyed through a fixed reaction zone of water (essentially, fed-batch for grain), or that the water is continuously conveyed through a fixed reaction zone of intermediate wheat grain (essentially, a fixed bed of grain).

Physically, the reactor may vary widely. The reactor may be a glass vessel, a plastic container, a metal vessel, a tank, or a section of pipe, for example. The size of the reactor also may vary widely, from small-scale laboratory vessels to pilot-plant reactors, demonstration-plant reactors, and commercial-scale reactors.

The mass ratio of water to the starting feedstock is preferably selected to provide excess water, which means that there is free water not taken up by the solids via adsorption or absorption. The mass ratio of water to the starting feedstock that provides excess water will depend on the exact starting feedstock, the temperature, the pH, and the pressure, since these reaction parameters will influence how much water is taken up by the biomass. Excess water avoids mass-transfer limitations associated with the treatment.

In some embodiments, the mass ratio of the water to the starting feedstock within the reactor is at least 10. In various embodiments, the mass ratio of the water to the starting feedstock within the reactor is about, at least about, or at most about 1, 2, 3, 4, 5, 6, 7, 8, 9, 10, 11, 12, 13, 14, 15, 16, 17, 18, 19, 20, or more, including any intervening range. There is no upper bound on the ratio although it needs to be finite in order to treat at least one particle of biomass. However, economics (e.g., reactor size) will dictate that the mass ratio of water to the starting feedstock is preferably less than 20, such as less than 10.

In some embodiments, the treated grain is characterized by at least 50% higher hydroxycinnamate extractability compared to the starting feedstock. In various embodiments, the treated grain is characterized by at least 25%, 50%, 75%, 100%, 150%, 200%, 250%, 300%, 400%, 500%, 600%, or higher hydroxycinnamate extractability compared to the starting feedstock.

In some embodiments, the process further comprises drying the treated grain after step (b) to generate a dried treated grain product. Drying may utilize any known drying unit, such as conventional grain dryers which may be batch or continuous. The drying unit may utilize heat, or may use no heat (e.g., natural-air dryers). The drying unit may heat drying air to only slightly above ambient temperature, i.e., to an air temperature of about 25° C. to about 35° C. The drying unit may heat drying air to a relatively high air temperature of about 35° C. to about 50° C., when using high-temperature or high-speed dryers. A propane-fired heaters may be used to heat the air and a high-capacity fan may be used to blow the heated air through the treated grain. In principle, the drying gas could be nitrogen, argon, CO₂, or another gas, but air is practical and economic.

When a drying unit is employed, the dried treated grain product may contain from about 1 wt % to about 20 wt % moisture, such as from about 5 wt % to about 15 wt % moisture. In various embodiments, the dried treated grain product contains about, or at most about, 0, 1, 2, 3, 4, 5, 6, 7, 8, 9, 10, 11, 12, 13, 14, 15, 16, 17, 18, 19, or 20 wt % moisture (H₂O), including any intervening range. In preferred embodiments, the dried treated grain product contains no greater than 14 wt % moisture.

In some embodiments, whether or not the treated grain is dried, the process further comprises comminuting the treated grain after step (b) to generate a milled treated grain flour product. The particle size of the milled treated grain flour product may vary widely, depending on the desired characteristics and intended use of the product. The average particle size of the milled treated grain flour product may be from about 10 microns to about 800 microns, such as from about 50 microns to about 400 microns, for example. In various embodiments, the average particle size of the milled treated grain flour product is about, at least about, or at most about 10, 25, 50, 75, 100, 150, 200, 250, 300, 350, 400, 450, 500, 550, 600, 650, 700, 750, or 800 microns, including any intervening range. The particle-size distribution may be unimodal, bimodal, or polymodal.

Particle sizes may be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

Hydroxycinnamates are found in plants bound to polysaccharides (ester bonds) or lignin (ether or ester bonds) in cell walls. Hydroxycinnamates are a class of aromatic acids or phenylpropanoids having a π-C₆-C₃ skeleton (π-C₆ denotes an aromatic ring of six carbon atoms). A hydroxycinnamate may have more than 9 total carbon atoms, since carbon-containing groups may be attached to the π-C₆-C₃ skeleton. Hydroxycinnamates, also known as hydroxycinnamic acids, are hydroxy derivatives of cinnamic acid. Three examples of hydroxycinnamates are ferulic acid, sinapinic acid, and p-coumaric acid. Ferulic acid, which is also known chemically as 3-methoxy-4-hydroxycinnamic acid, has the stoichiometry HOC₆H₃(OCH₃)CH═CHCO₂H. The IUPAC name of ferulic acid is (2E)-3-(4-hydroxy-3-methoxyphenyl) prop-2-enoic acid. Sinapinic acid also known chemically as 3,5-dimethoxy-4-hydroxycinnamic acid. p-Coumaric acid is also known as 4-hydroxycinnamic acid.

In some embodiments, the hydroxycinnamate extractability is determined by measuring concentration of ferulic acid following chemical extraction of the treated grain. This is a laboratory extraction to determine hydroxycinnamate extractability of the treated grain. Alternatively, or additionally, the hydroxycinnamate extractability may be determined according to aroma. This is a practical technique to determine hydroxycinnamate extractability of the treated grain.

When the hydroxycinnamate extractability is determined using chemical extraction of ferulic acid, the extraction may be performed using enzymatic, alkaline, or acidic extraction. Extraction conditions are needed to break the hydroxycinnamate bonds from polysaccharides and lignin, but to not oxidize the hydroxycinnamates. To differentiate from aroma testing, the term “laboratory extraction” is used, to refer to any extraction technique external to the human body. That is, a laboratory extraction is not related to eating or masticating and tasting the grain product, or a cooked version thereof. Laboratory extraction includes extractions understood by those skilled in the art as physiochemical extractions conducted by experienced practitioners using laboratory equipment and a suitable extraction solvent.

It is important to note that the hydroxycinnamate extractability refers to the hydroxycinnamate compounds that are readily extractable. By “readily extractable” it is meant that the relative amount of hydroxycinnamates which are extracted using physiochemical extraction methods are insufficient to extract all or substantially all of the absolute amount of hydroxycinnamates that are present in a specific material. Methods that extract all hydroxycinnamates present in a specific material might not demonstrate a substantive change in the hydroxycinnamate extractability as a result of the disclosed process. The reason for that is, since no chemical degradation of hydroxycinnamates is expected during the disclosed treatment, the total mass of hydroxycinnamates is the same before and after treatment. If a severe extraction (e.g., destructive analysis) technique was used that measured the absolute total hydroxycinnamate concentration, the benefit would be masked. Furthermore, the readily extractable hydroxycinnamate content is regarded as more pertinent for most uses of the treated grain product. During human consumption, readily extractable hydroxycinnamates can contribute to aroma, whereas non-readily-extractable hydroxycinnamates will not be expected to contribute to aroma since the food will be consumed or digested before the non-readily-extractable hydroxycinnamates have a chance to contact taste buds or nerve cells that transmit aroma signals to the brain.

Note that “aroma” in this patent application relates to both smell and taste. From a sensory science perspective, taste is defined as those attributes that can be sensed on the tongue, which are saltiness, sweetness, sourness, bitterness, and umami. Aroma is defined as an odor, sensed ortho-nasally through the nose and retro-nasally through the back of the mouth. Therefore, aroma contributes to taste, especially in the case of volatile compounds. The sensation of flavor is a combination of taste and smell. During chewing, air is forced through a nasal passage. Food odors are detected by receptor proteins on hair-like cilia at the tips of the sensory cells in the nose, which in turn send neural messages to the brain. These are sensory two messages are perceived as a flavor or a taste, which are both included in an aroma. The physiochemical extraction in the mouth from mastication releases volatiles, which are perceived as a taste by a human. Whether or not those volatiles are directly sensed ortho-nasally, retro-nasally, or by direct contact with taste buds, the sensing is within the meaning of “aroma” as intended herein.

In some embodiments in which the hydroxycinnamate extractability is determined using aroma, the aroma of a treated grain is evaluated via a sensory triangle test, which is a well-known methodology in the field of sensory science. The sensory triangle test shows if there is a difference between samples. The sensory triangle test may utilize unmilled treated grain, or a flour form of the treated grain.

In some embodiments in which the hydroxycinnamate extractability is determined using aroma, the aroma is measured using treated grain that has been milled into a flour. The flour can then be evaluated and compared for aroma using a descriptive sensory analysis panel that evaluates a baked product prepared with the comminuted treated grain (flour). The descriptive sensory analysis panel data shows the degree of difference in the spicy/cinnamon/sweet flavor between baked samples.

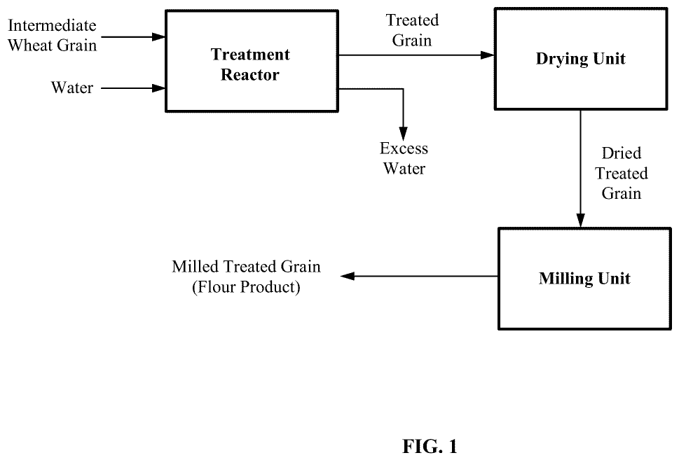

FIG. 1 depicts an exemplary, simplified block-flow diagram of the process of the invention, in some variations. In FIG. 1, intermediate wheat grain (or a feedstock comprising intermediate wheat grain) is fed to a treatment reactor, along with water or an aqueous solution. One or more additives (such as pH modification agents) may be introduced to the treatment reactor. Following treatment at the selected processing conditions, the treated grain is separated from excess water. The treated grain is conveyed to a drying unit configured for drying the treated grain, either partially or completely. The dried treated grain is conveyed to a milling unit, configured for comminuting the dried treated grain into a flour product. The flour product is recovered and may be stored, sold, or further processed. The flour product has enhanced hydroxycinnamate extractability compared to the starting intermediate wheat grain.

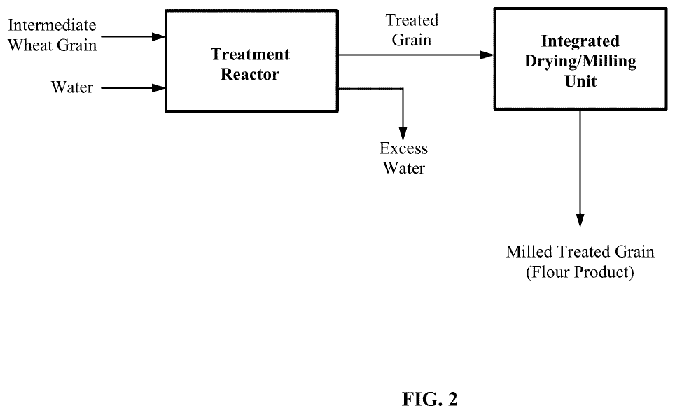

FIG. 2 depicts an exemplary, simplified block-flow diagram of the process of the invention, in some variations. In FIG. 2, intermediate wheat grain (or a feedstock comprising intermediate wheat grain) is fed to a treatment reactor, along with water or an aqueous solution. One or more additives (such as pH modification agents) may be introduced to the treatment reactor. Following treatment at the selected processing conditions, the treated grain is separated from excess water. The treated grain is conveyed to an integrated drying/milling unit configured for both drying and comminuting the treated grain into a flour product. In an integrated drying/milling unit, there may be sequential drying and then milling, or the milling may be applied to the particles as they are being dried (simultaneous milling/drying). Milling may assist drying by reducing particle size and allowing more efficient water escape. The flour product is recovered and may be stored, sold, or further processed. The flour product has enhanced hydroxycinnamate extractability compared to the starting intermediate wheat grain.

In all embodiments, the intermediate wheat grain fed to the treatment reactor is usually not harvested material directly from the field. The intermediate wheat grain is typically pre-processed following harvest, as is known in the art. For example, during harvesting, intermediate wheatgrass is separated into a grain-rich fraction, and a grass-rich fraction, which may remain on the field or be collected as well. The grain-rich fraction may then be cleaned, such as with the use of a vibrating sieve, impact dehuller, and aspirator. Preferably, the hulls (husks) are removed from the grain kernels. An impact dehuller uses physical forces to separate the hulls, and an aspirator may be used for cleaning the dust and husks out of the grain.

The mass fraction of a harvested intermediate wheatgrass that may be used as intermediate wheat grain for processing may be from about 25 wt % to about 75 wt %, such as from about 30 wt % to about 50 wt %, for example. However, in some embodiments, mass fractions even higher than 75 wt % of a harvested intermediate wheatgrass may be used. For example, in certain embodiments, such as those which target the production of a hydroxycinnamate (e.g., ferulic acid) rather than a flour intended for baking, the intermediate wheat grain may be treated along with the hulls—or even as whole wheatgrass treatment, feeding the entire harvested wheatgrass, without threshing, to the reactor.

In some embodiments, the starting feedstock contains from about 50 wt % to 100 wt % of grain from Thinopyrum intermedium on a dry basis. In typically embodiments, the starting feedstock consists essentially of grain from Thinopyrum intermedium on a dry basis (there can be and usually is some moisture present). In various embodiments, the starting feedstock contains about, at least about, or at most about 50 wt %, 60 wt %, 70 wt %, 80 wt %, 90 wt %, 95 wt %, 99 wt %, 99.5 wt %, 99.9 wt %, or 100 wt % of grain from Thinopyrum intermedium on a dry basis. When the starting feedstock contains less than 100% (dry weight basis) of the Thinopyrum intermedium grain, the other components may be non-grain components of Thinopyrum intermedium (e.g., material from the hulls or stalks), grain that is not from Thinopyrum intermedium, other forms of biomass, ash, dirt, etc. The starting feedstock may contain less than 50 wt % of grain from Thinopyrum intermedium on a dry basis, but this is less preferred due to economics.

The present invention is not limited to the version of Thinopyrum intermedium known commercially as Kernza. As is known, Thinopyrum intermedium may be domesticated through mass breeding and selection to create a strain that increases the seed size and yield but retains natural resistance, hardiness, and perenniality. Thinopyrum intermedium may also be hybridized with conventional wheat (e.g., Triticum aestivum, known as common wheat) to create a strain that retains resistance and perenniality while retaining common wheat's seed size and yield. It is also possible to genetically modify Thinopyrum intermedium, such as via targeted mutagenesis, genome editing, to further improve characteristics and/or accelerate perennial domestication.

As an example of a modified Thinopyrum intermedium, “MN-Clearwater” (Reg. No. CV-287, PI 692651) is the world's first commercial food-grade intermediate wheatgrass grain cultivar. MN-Clearwater was developed as a synthetic population at the University of Minnesota, St. Paul, Minnesota, and released in August 2019. MN-Clearwater was created by intercrossing seven parents selected for high grain yield, reduced shattering, high free grain threshing, reduced lodging, and uniform maturity. MN-Clearwater grain is currently sold as Kernza perennial grain.

The Thinopyrum intermedium that is treated in the disclosed technology may have a DNA genome nucleotide sequence that is at least 80% homologous, such as at least 90%, at least 95% at least 96%, at least 97%, at least 98%, at least 99%, or 100% homologous with the Thinopyrum intermedium disclosed publicly in Reg. No. CV-287, PI 692651 (see Bajgain et al., “‘MN-Clearwater’, the first food-grade intermediate wheatgrass (Kernza perennial grain) cultivar”, Journal of Plant Registrations, Volume 14, Issue 3, September 2020, Pages 288-297, which is hereby incorporated by reference herein. The technique to determine the DNA genome sequence and to measure DNA nucleotide sequence homology can be found in Qi et al., “Genome Analysis of Thinopyrum intermedium and Its Potential Progenitor Species Using Oligo-FISH”, Plants 2023, 12, 3705, which is hereby incorporated by reference herein. Quantification of homology may utilize the well-known Basic Local Alignment Search Tool (BLAST).

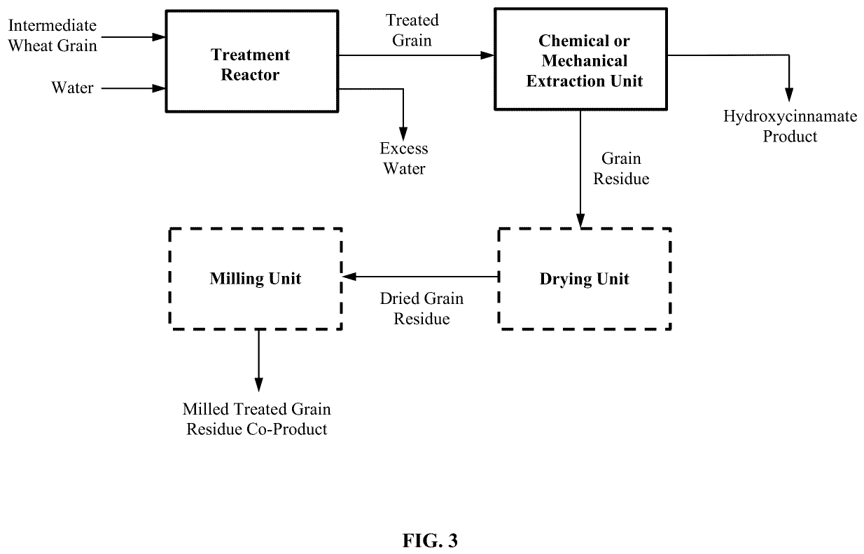

FIG. 3 depicts an exemplary, simplified block-flow diagram of the process of the invention, in some variations. Dotted lines denote optional unit operations. In FIG. 3, intermediate wheat grain (or a feedstock comprising intermediate wheat grain) is fed to a treatment reactor, along with water or an aqueous solution. One or more additives (such as pH modification agents) may be introduced to the treatment reactor. Following treatment at the selected processing conditions, the treated grain is separated from excess water. The treated grain is conveyed to a chemical or mechanical extraction unit, configured for chemically and/or mechanically extracting hydroxycinnamates from the treated grain. The extracted hydroxycinnamates are recovered as a hydroxycinnamate product and may be stored, sold, or further processed. The grain residue, following extraction, is optionally conveyed to a drying unit configured for drying the grain residue. The dried grain residue (or the undried grain residue) is optionally conveyed to a milling unit configured for comminuting the grain residue into a milled co-product. The milled co-product may be recovered and stored, sold, or further processed.

The hydroxycinnamate product in FIG. 3 may be ferulic acid, for example. Ferulic acid has low toxicity and has been reported in the literature to provide many physiological functions, such as anti-inflammatory, antioxidant, antimicrobial, and antidiabetic activities. Ferulic acid has been widely used in the pharmaceutical, food, and cosmetics industry.

The structure of ferulic acid is shown below. It can be readily observed that the molecule contains interesting functional groups, including an aromatic group, a C═C double bond, a hydroxyl group, and a carboxylate group. Therefore, ferulic acid can be a feedstock for making various biochemicals and biofuels. The ferulic acid could be polymerized into poly(ferulic acid), or hydrotreated into liquid fuels, for example.

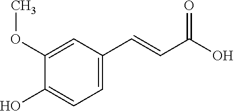

Other variations of the invention provide a treated intermediate wheat grain product produced by a process comprising:
(a) providing a starting feedstock comprising grain from Thinopyrum intermedium;
(b) treating the starting feedstock in a reactor in the presence of water, wherein the starting feedstock is treated for a treatment time selected from about 1 hour to about 8 hours, wherein the starting feedstock is treated at a treatment temperature selected from about 10° C. to about 35° C., wherein the starting feedstock is treated at a treatment pH selected from about 5.0 to about 8.0, and wherein the mass ratio of the water to the starting feedstock within the reactor is at least 1, thereby generating a treated grain; and
(c) recovering the treated grain as a treated intermediate wheat grain product, wherein the treated intermediate wheat grain product is characterized by at least 25% higher hydroxycinnamate extractability compared to the starting feedstock.

In some product embodiments, the treatment time is selected from about 2 hours to about 6 hours. In various embodiments, the treatment time is selected as about, at least about, or at most about 1, 1.5, 2, 2.5, 3, 3.5, 4, 4.5, 5, 5.5, 6, 6.5, 7, 7.5, or 8 hours, including any intervening range.

In some product embodiments, the treatment temperature is selected from about 15° C. to about 25° C. In various embodiments, the treatment temperature is selected as about, at least about, or at most about 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., or 35° C., including any intervening range.

In some product embodiments, the treatment pH is selected from about 5.6 to about 7.5. In various embodiments, the treatment pH is selected as about, at least about, or at most about 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, or 8.0, including any intervening range.

In some product embodiments, the mass ratio of the water to the starting feedstock within the reactor is at least 10. In various embodiments, the mass ratio of the water to the starting feedstock within the reactor is about, at least about, or at most about 1, 2, 3, 4, 5, 6, 7, 8, 9, 10, 11, 12, 13, 14, 15, 16, 17, 18, 19, 20, or more, including any intervening range.

The treated intermediate wheat grain product may be characterized by at least 50% higher hydroxycinnamate extractability compared to the starting feedstock. In various embodiments, the treated intermediate wheat grain product is characterized by at least 25%, 50%, 75%, 100%, 150%, 200%, 250%, 300%, 400%, 500%, 600%, or higher hydroxycinnamate extractability compared to the starting feedstock.

In some product embodiments, the process further comprises drying the treated grain after step (b) to generate a dried product.

In some product embodiments, the process further comprises comminuting the treated grain after step (b) to generate a flour product.

The hydroxycinnamate extractability of the treated intermediate wheat grain product may be determined by measuring concentration of ferulic acid following chemical extraction of the treated grain. Alternatively, or additionally, the hydroxycinnamate extractability of the treated intermediate wheat grain product may be determined according to aroma.

Other variations of the invention provide a treated intermediate wheat grain product characterized by a ferulic acid extraction concentration from about 50 μg/mL to about 200 μg/mL, such as from about 100 μg/mL to about 150 μg/mL, when the extraction protocol described in Example 2 is applied to the treated intermediate wheat grain product.

One skilled in the art will recognize that there are various alternatives and other embodiments that utilize the principles of the invention. For example, the treatment process may be applied to another grain besides grain from Thinopyrum intermedium. Hydroxycinnamate-containing grains include wheat, rice, oat, corn, and barley.

Some variations provide a process for treating a hydroxycinnamate-containing grain to enhance its hydroxycinnamate extractability, the process comprising:
(a) providing a starting feedstock comprising a hydroxycinnamate-containing grain;
(b) treating the starting feedstock in a reactor in the presence of water, wherein the starting feedstock is treated for a treatment time selected from about 1 hour to about 8 hours, wherein the starting feedstock is treated at a treatment temperature selected from about 10° C. to about 35° C., wherein the starting feedstock is treated at a treatment pH selected from about 5.0 to about 8.0, and wherein the mass ratio of the water to the starting feedstock within the reactor is at least 1, thereby generating a treated grain; and
(c) recovering the treated grain, wherein the treated grain is characterized by at least 25% higher hydroxycinnamate extractability compared to the starting feedstock.

The order of steps may also be varied. For example, a flour may be produced from grain from Thinopyrum intermedium, and then the flour is treated in the treatment reactor.

Some variations provide a process for treating intermediate wheat to enhance its hydroxycinnamate extractability, the process comprising:
(a) providing a starting feedstock comprising grain from Thinopyrum intermedium;
(b) drying and milling the starting feedstock to generate a grain flour;
(c) treating the grain flour in a reactor in the presence of water, wherein the grain flour is treated for a treatment time selected from about 1 hour to about 8 hours, wherein the grain flour is treated at a treatment temperature selected from about 10° C. to about 35° C., wherein the grain flour is treated at a treatment pH selected from about 5.0 to about 8.0, and wherein the mass ratio of the water to the grain flour within the reactor is at least 1, thereby generating a treated grain flour; and
(d) recovering the treated grain flour, wherein the treated grain flour is characterized by at least 25% higher hydroxycinnamate extractability compared to the grain flour and/or compared to the (unmilled) starting feedstock.

Some variations provide a process for treating intermediate wheat to enhance its hydroxycinnamate extractability, the process comprising:
(a) providing a starting feedstock comprising grain from Thinopyrum intermedium;
(b) drying the starting feedstock to generate a dried grain;
(c) milling the dried grain to generate a grain flour;
(d) treating the grain flour in a reactor in the presence of water, wherein the grain flour is treated for a treatment time selected from about 1 hour to about 8 hours, wherein the grain flour is treated at a treatment temperature selected from about 10° C. to about 35° C., wherein the grain flour is treated at a treatment pH selected from about 5.0 to about 8.0, and wherein the mass ratio of the water to the grain flour within the reactor is at least 1, thereby generating a treated grain flour; and
(e) recovering the treated grain flour, wherein the treated grain flour is characterized by at least 25% higher hydroxycinnamate extractability compared to the grain flour and/or compared to the starting feedstock.

Some variations provide a process for treating intermediate wheat to enhance its hydroxycinnamate extractability, the process comprising:
(a) providing a starting feedstock comprising grain from Thinopyrum intermedium;
(b) milling the starting feedstock to generate a milled wet grain;
(c) drying the milled wet grain to generate a grain flour;
(d) treating the grain flour in a reactor in the presence of water, wherein the grain flour is treated for a treatment time selected from about 1 hour to about 8 hours, wherein the grain flour is treated at a treatment temperature selected from about 10° C. to about 35° C., wherein the grain flour is treated at a treatment pH selected from about 5.0 to about 8.0, and wherein the mass ratio of the water to the grain flour within the reactor is at least 1, thereby generating a treated grain flour; and
(e) recovering the treated grain flour, wherein the treated grain flour is characterized by at least 25% higher hydroxycinnamate extractability compared to the grain flour and/or compared to the starting feedstock.

The throughput, or process capacity, may vary widely from small laboratory-scale units to full commercial-scale units. In various embodiments, the process capacity in terms of production of kilograms of treated grain product is at least about 1 kg/day, 10 kg/day, 100 kg/day, 1 ton/day (all tons are metric tons), 10 tons/day, 100 tons/day, 1000 tons/day, or higher.

### EXAMPLES

### Example 1: Increasing the Hydroxycinnamate Extractability of Intermediate Wheat Grain

Portions of intermediate wheatgrass grain, Kernza, weighing 5-30 grams were placed into cheesecloth prior to being assigned to one of the following two groups: (I) submersed in water at about 21° C. for 4 hours or (II) not submersed in water. After four hours the water-submerged portions were separated from the water and excess water removed via gravity for 1 hour.

Both groups I and II were then conditioned at 30° C. overnight. After conditioning 0.5 gram of each portion was added to four milliliters of 3M NaOH and then sonicated at room temperature for 90 minutes. After sonicating, the pH was lowered to 6 with 2M HCl followed by centrifuging at 3,000×g for 10 minutes (g is the force of gravity). The liquid was removed to a new container and 2 mL diethyl ether added followed by vortex mixing and centrifuging at 3,000×g for ten minutes. For each sample, the ether layer was removed to a separate container and the ether layer was dried off prior to reconstitution in 1 mL of 1:1 water: methanol. The reconstituted material was filtered through a 0.2 μm filter in preparation for analysis by high-performance liquid chromatography (HPLC). The aqueous sample was also filtered in preparation for analysis by HPLC.

For the HPLC analysis, separation occurred on a Thermo BDS Hypersil C18 column (150×4 mm, 3 M), with an injection volume of 10 μL and the samples stored in a cooled autosampler at 4° C. The mobile phase solutions consisted of 0.085 wt % phosphoric acid in water (Mobile Phase A) and 100 wt % acetonitrile (Mobile Phase B). A HPLC gradient was employed using 10%-22% B over 13 minutes, increased to 40% B over 1 minute, then decreased to 10% B over another 1 minute, then 5 minutes of equilibration before the next sample. The total run time was 20 minutes with a flow rate of 1.0 mL/min. An ultraviolet detector was used with a detection wavelength of 325 nm.

According to the HPLC results, ferulic acid detected compared to standards for the treated sample was 36.9 μg/mL, compared to 22.0 μg/mL for the untreated control. This equates to the treated grain having 68% higher hydroxycinnamate extractability compared to the control.

### Example 2: Increasing the Hydroxycinnamate Extractability of Intermediate Wheat Grain

Portions of Kernza grain, intermediate wheatgrass, weighing 5-30 grams were assigned to one of the following groups: (I) submersed in 400-600 milliliters of water for 1, 2, 4, 8 hours at a temperature of about 25° C., or (II) untreated.

After 8 hours the water-submerged portion of the grain was separated from the excess water and placed in a separate container from the untreated portion. The wet grain was dried for 18 hours at 21° C.

After drying both portions were then extracted by the following chemical extraction method. After conditioning 0.5 gram of each portion was added to four milliliters of 3M NaOH and then sonicated at room temperature for 90 minutes. After sonicating the pH was lowered to 6 with 2M HCl followed by centrifuging at 3,000×g for 10 minutes. The liquid was removed to a new container and 2 mL diethyl ether added followed by vortex mixing and centrifuging at 3,000×g for ten minutes. Each ether layer was removed to a separate container and the ether layer was dried off prior to reconstitution in 1 mL of 1:1 water: methanol. The reconstituted material was filtered through a 0.2 μm filter in preparation for analysis by HPLC. The aqueous sample was also filtered in preparation for analysis by HPLC.

For the HPLC analysis, separation occurred on a Thermo BDS Hypersil C18 column (150×4 mm, 3 M), with an injection volume of 10 μL and the samples stored in a cooled autosampler at 4° C. The mobile phase solutions consisted of 0.085 wt % phosphoric acid in water (Mobile Phase A) and 100 wt % acetonitrile (Mobile Phase B). A HPLC gradient was employed using 10%-22% B over 13 minutes, increased to 40% B over 1 minute, then decreased to 10% B over another 1 minute, then 5 minutes of equilibration before the next sample. The total run time was 20 minutes with a flow rate of 1.0 mL/min. An ultraviolet detector was used with a detection wavelength of 325 nm.

According to the HPLC results, ferulic acid detected compared to standards for samples treated for 1, 2, 4 and 8 hours were 131.0 μg/mL, 140.3 μg/mL, 119.8 μg/mL, and 148.5 μg/mL, respectively, compared to 22.0 μg/mL for the untreated control. These results equate to the treated grain having 595%, 637%, 545%, and 675% higher hydroxycinnamate extractability compared to the control. Based on those results, the hydroxycinnamate extractability of the starting grain from Thinopyrum intermedium was significantly improved using the treatment, compared to the untreated control. The degree of improvement was surprising and unexpected.

### Example 3: Increasing the Hydroxycinnamate Extractability of Intermediate Wheat Grain

Portions of cleaned and dehulled Kernza grain, intermediate wheatgrass, were assigned to one of the following groups: (I) submersed in an amount of water for 4 hours or (II) untreated. After four hours the water submerged portion of the grain was separated from the excess water and placed in a separate container from the untreated portion. The wet grain was dried for 18 hours at 21° C.

The aroma of the untreated control and the treated Kernza samples was compared via a sensory triangle test at Southwest Minnesota State University. The triangle test is a discriminative method used to gauge if an overall difference is present between two products. Participants evaluated three samples and were asked to select the one that was different. Sample sets were randomized and were made up of a combination of two treated and one untreated or two untreated and one treated sample. Nine participants were presented with two randomized sets to evaluate at their own pace for a total of eighteen responses. The odd sample was correctly identified in 67% of the responses (p=0.0027), indicating a difference in the aroma between the samples.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

What is claimed is:

1. A process for treating intermediate wheat to enhance its hydroxycinnamate extractability, said process comprising:
(a) providing a starting feedstock comprising grain from Thinopyrum intermedium;
(b) treating said starting feedstock in a reactor in the presence of water, wherein said starting feedstock is treated for a treatment time selected from about 1 hour to about 8 hours, wherein said starting feedstock is treated at a treatment temperature selected from about 10° C. to about 35° C., wherein said starting feedstock is treated at a treatment pH selected from about 5.0 to about 8.0, and wherein the mass ratio of said water to said starting feedstock within said reactor is at least 1, thereby generating a treated grain; and
(c) recovering said treated grain, wherein said treated grain is characterized by at least 25% higher hydroxycinnamate extractability compared to said starting feedstock.

2. The process of claim 1, wherein said treatment time is selected from about 2 hours to about 5 hours.

3. The process of claim 1, wherein said treatment temperature is selected from about 15° C. to about 25° C.

4. The process of claim 1, wherein said treatment pH is selected from about 5.6 to about 7.5.

5. The process of claim 1, wherein said mass ratio of said water to said starting feedstock within said reactor is at least 10.

6. The process of claim 1, wherein said treated grain is characterized by at least 50% higher hydroxycinnamate extractability compared to said starting feedstock.

7. The process of claim 1, wherein said process further comprises drying said treated grain after step (b) to generate a dried treated grain product.

8. The process of claim 1, wherein said process further comprises comminuting said treated grain after step (b) to generate a milled treated grain flour product.

9. The process of claim 1, wherein said hydroxycinnamate extractability is determined by measuring concentration of ferulic acid following chemical extraction of said treated grain.

10. The process of claim 1, wherein said hydroxycinnamate extractability is determined according to aroma.

11. A treated intermediate wheat grain product produced by a process comprising:
(a) providing a starting feedstock comprising grain from Thinopyrum intermedium;
(b) treating said starting feedstock in a reactor in the presence of water, wherein said starting feedstock is treated for a treatment time selected from about 1 hour to about 8 hours, wherein said starting feedstock is treated at a treatment temperature selected from about 10° C. to about 35° C., wherein said starting feedstock is treated at a treatment pH selected from about 5.0 to about 8.0, and wherein the mass ratio of said water to said starting feedstock within said reactor is at least 1, thereby generating a treated grain; and
(c) recovering said treated grain as a treated intermediate wheat grain product, wherein said treated intermediate wheat grain product is characterized by at least 25% higher hydroxycinnamate extractability compared to said starting feedstock.

12. The treated intermediate wheat grain product of claim 11, wherein said treatment time is selected from about 2 hours to about 5 hours.

13. The treated intermediate wheat grain product of claim 11, wherein said treatment temperature is selected from about 15° C. to about 25° C.

14. The treated intermediate wheat grain product of claim 11, wherein said treatment pH is selected from about 5.6 to about 7.5.

15. The treated intermediate wheat grain product of claim 11, wherein said mass ratio of said water to said starting feedstock within said reactor is at least 10.

16. The treated intermediate wheat grain product of claim 11, wherein said treated intermediate wheat grain product is characterized by at least 50% higher hydroxycinnamate extractability compared to said starting feedstock.

17. The treated intermediate wheat grain product of claim 11, wherein said process further comprises drying said treated grain after step (b) to generate a dried product.

18. The treated intermediate wheat grain product of claim 11, wherein said process further comprises comminuting said treated grain after step (b) to generate a flour product.

19. The treated intermediate wheat grain product of claim 11, wherein said hydroxycinnamate extractability is determined by measuring concentration of ferulic acid following chemical extraction of said treated grain.

20. The treated intermediate wheat grain product of claim 11, wherein said hydroxycinnamate extractability is determined according to aroma.
